(19) United States
(12) Patent Application Publication
(10) Pub. No.: US 2008/0110929 A1
(43) Pub. Date: May 15, 2008

(54) Fluid dispensing cap & bottle assembly

(76) Inventors: E. Lawrence Stanley Traasdahl, Las Vegas, NV (US); Jeremy Lamanna, Las Vegas, NV (US); David Michael Webb, Las Vegas, NV (US)

Correspondence Address: MICHAEL PHILIP ARTEMIS, 1483 Grendon Way, Gardenrville, NV, 89410, US

(21) Appl. No.: 11/600,960

(22) Filed: Nov. 15, 2006

(51) Int. Cl. B67D 5/08; B65D 25/40; B65D 53/00; B65D 25/20; B65B 7/28

(52) U.S. Cl. 222/109; 222/566; 220/304; 220/713; 215/44

(57) ABSTRACT

A fluid dispensing cap and beverage bottle assembly provides a spill-resistant container for use by a small child. The dispensing cap has a perforated baffle that restricts the beverage flow under static pressure conditions and permits beverage flow when a sufficient pressure differential is applied across the baffle. The dispensing cap includes a spout that facilitates beverage consumption. The dispensing cap either screws onto a bottle neck or is a press-fit cap that is inserted into the bottle's open end. A seal is provided that prevents beverage leakage and indicates if the container has been tampered with or compromised.

### FIELD OF THE INVENTION

The present invention relates to a spill-resistant drinking container for children and more particularly, to a container that allows a child to consume a pre-packaged bottled beverage with a reduced risk of spilling.

### BACKGROUND OF THE INVENTION

In today's society people are constantly busy taking care of families, personal business, and attending various activities of interest. While people are tending to their various activities, they commonly require a quick way to purchase necessary items. As a result, convenience stores have become a frequent stop for people to quickly purchase items such as groceries, snacks, beverages, gasoline and other sundries. One very popular item that is frequently purchased in a convenience store is a pre-packaged bottled beverage or soft drink. For example, people generally find it very convenient to purchase a nice cool drink, such as bottled water, while refueling their automobile at a convenience store.

However, when a person is running errands and tending to a small child the person often has a need to provide the child with a beverage. As a result, the person usually has to bring a beverage from home that is in a suitable container for use by the small child. Commonly, a person or parent may fill a children's drinking cup (e.g., “sippy-cup”) with water or juice prior to leaving home. A sippy-cup is a small refillable container that has a spout from which the child draws the beverage and a cup that is generally sized for a child's portion.

One teaching of a traditional sippy-cup is found in U.S. Pat. No. 6,976,604 to Connors, Jr. et al., the disclosure of which is hereby incorporated by reference. The '604 patent teaches the use of a disposable child's drinking cup that has a lid with a drinking spout defining multiple holes sized to resist leakage in the absence of suction, and to allow flow when suction is applied. The holes are formed during molding of the lid. This approach enables the person or parent to provide a beverage to a child in a container suitable for the child to use during consumption of the beverage. While useful, this disclosure requires that the person or parent fill the drinking cup before the child may consume a beverage. Furthermore, this drinking cup is not provided in pre-packaged bottle beverage form that is sold pre-filled with a beverage. Another disadvantage is that the person or parent is must prepare the drinking cup prior to running any errands. Still another disadvantage is that overtime the beverage may become too warm for the small child's preference and the beverage may not be consumed. Additionally, the child's beverage may require refilling and as a result the person or parent is required to bring a secondary container with adequate supply of the beverage by which the child's drinking cup may be replenished.

Another option for the person or parent is to purchase a beverage for the child while running errands, usually from a convenience store. While this option appears to be quite convenient at first glance, in reality finding a pre-packaged bottled beverage, suitable for the small child, is rather difficult for several reasons. First, the portion size of most bottled beverages is not suitable for a small child, as the portion is usually too large for the child to consume. As a result a substantial portion of the beverage is frequently wasted or spilled.

Second, the bottled beverages are not provided in a container designed for use by a small child. For example, the bottled beverages usually have a cap that requires unscrewing from the container, or a pull-type or flip-type valve that has small parts and requires substantial force to open. In the past, inventors have attempted to provide solutions to problematic beverage containers. One inventive teaching for a drink-through spout cap is found in U.S. Pat. No. 6,112,926 to Fishman, the disclosure of which is hereby incorporated by reference. The '926 patent teaches the use of a molded plastic pyramid shaped drink-through spout cap that is non-closable. The disclosure of this reference is specifically directed to an adapter cap that is screwed onto a beverage bottle by a user. While this invention is somewhat useful, this particular arrangement requires the user to previously acquire a pre-packaged bottled beverage and then replace the original cap of the bottle beverage with the cap of the disclosed invention. Furthermore, the '926 patent does not teach nor provide a spill-resistant cap or a cap that is closable or sealable. This drink-through cap is not provided in pre-packaged bottle beverage form that is sold with the beverage.

Finally, the currently available pre-packaged bottled beverages lack child spill-resistant provisions and as a consequence the child is very likely to spill the beverage. One teaching of a flow control element is found in U.S. Pat. No. 6,991,122 to Holley, Jr., the disclosure of which is hereby incorporated by reference. The '122 patent teaches the use of a flow control element that includes a tube-like wall section defining a flow channel, and a substantially flat membrane supported by the wall section such that the membrane impedes flow through the flow channel to an external region. The membrane is punctured to form multiple, substantially round pinholes arranged in a two-dimensional pattern that remain closed to prevent fluid flow under normal atmospheric conditions, and open to facilitate fluid flow rate through the membrane under an applied pressure differential. The membrane is formed from a relatively highly elastic material. Different sized pinholes are produced using different sized pins, thereby facilitating different flow rates in response to different applied pressure differentials. This approach is specifically directed to providing increased flow rate as the pressure differential changes. While useful, this disclosure requires that the flow control element be fabricated from an elastic material that deforms in response to the changes in the pressure differential across the membrane. Through this deformation, the size of the pinholes expand and contract to provide increased or decreased flow rates, respectively. Additionally, this flow control element is not provided in combination with a pre-packaged bottle beverage.

Correspondingly, currently available pre-packaged bottled beverages still suffer from severe deficiencies in failing to provide a child's spill-resistant container, a child's sized beverage portion, a beverage container suitable for use by a small child. Past efforts to provide a pre-packaged bottled beverage devoid of the noted disadvantages have not met with significant success to date.

### SUMMARY OF THE INVENTION

The present invention is a child's fluid dispensing cap and bottle assembly enabling the child to consume a child's portion of a pre-packaged bottled beverage from a convenient spill-resistant container.

In one embodiment, the invention comprises a spill-resistant fluid dispensing cap with a substantially hollow cylindrical base member. The base member has a top surface, a bottom end, an inner surface and an outer surface. The cap includes a drinking spout integrally formed on the top surface and extending generally outwardly therefrom. The spout defines an outlet passage through which the beverage is dispensed. The dispensing cap further includes a perforated baffle coupled to the base member. The baffle has a plurality of holes, for providing a fluid pathway through the baffle. The holes are sized such that fluid flow through the baffle commences when a pressure differential is applied across the baffle.

The invention further comprises an inner surface of the base member that is threaded in order to operatively engage an associated bottle having an externally threaded neck portion for receiving the dispensing cap. Alternately, another embodiment includes a plurality of circumferential ribs integrally formed on the outer surface of the base member in which the ribs are configured for press-fit engagement within a bottle neck. The invention further includes a perforated baffle that is integrally formed with the base member and may further have the perforated baffle integrally formed with the bottom end of the base member.

In one embodiment the dispensing cap includes a sealing member coupled with the outlet passage of the drinking spout that prevents leakage and provides an indication of tampering. The dispensing cap may also be coupled with a beverage bottle in which the bottle has a beverage storage volume of about 2 to 8 fluid ounces.

In yet another embodiment, the invention provides a spill-resistant fluid dispensing cap having a substantially hollow cylindrical base member. The base member is formed with a top surface, a bottom end, an inner surface and an outer surface. The inner surface is threaded in order to operatively engage an associated bottle having an externally threaded neck portion for receiving the dispensing cap. The dispensing cap further includes a drinking spout integrally formed on the top surface and extending generally outwardly therefrom. The drinking spout additionally defines an outlet passage through which the beverage is dispensed. A perforated baffle is coupled with the base member in which the baffle has a plurality of holes for providing a fluid pathway through the baffle. The holes are sized such that fluid flow through the baffle commences when a pressure differential is applied across the baffle. Additionally the dispensing cap includes a sealing member operatively coupled with the outlet passage.

The spill-resistant fluid dispensing cap may further include a perforated baffle that is integrally formed with the top surface of the base member. The dispensing cap may additionally be coupled with a beverage bottle in which the bottle has a beverage storage volume of about 2 to 8 fluid ounces.

In another embodiment, the invention combines a beverage bottle and a spill-resistant fluid dispensing cap. The beverage bottle has a beverage storage volume, and a bottle neck configured for operative coupling with the spill-resistant fluid dispensing cap. The coupling of the fluid dispensing cap with the beverage bottle enables drinking of a fluid contained within the beverage storage volume only when a pressure differential is applied across a perforated baffle.

The dispensing cap has a substantially hollow cylindrical base member in which the base member includes a top surface, a bottom end, an inner surface and an outer surface. The dispensing cap also includes a drinking spout integrally formed on the top surface and extending generally outwardly therefrom. The drinking spout defines an outlet passage through which the beverage is dispensed. A perforated baffle is coupled with the base member, the baffle has a plurality of holes for providing a fluid pathway through the baffle. The holes being sized such that fluid flow through the baffle commences when a pressure differential is applied across the baffle.

The invention additional includes a spill-resistant fluid dispensing cap with an inner surface of the base member that is threaded in order to operatively engage an associated bottle having an externally threaded neck portion for receiving the dispensing cap. Alternately, the spill-resistant fluid dispensing cap of claim may further comprise a plurality of circumferential ribs integrally formed on the outer surface, in which the ribs are configured for press-fit engagement within a bottle neck.

The invention provides a spill-resistant pre-packaged bottled beverage container for use by small children. As a result, a person or parent taking care of a small child can provide the child with a beverage and not have to worry about spilling a substantial portion of the beverage. This is especially beneficial when traveling with a small child because spills inside a vehicle are less likely and there is a reduced concern of having the child's clothing saturated with the beverage. Additionally, the spill resistant functionality of the present invention reduces the concern of damage to adjacent surfaces in the event of a spill.

Additionally, the invention enables the preparation of a store bought pre-packaged bottled beverage that contains a child sized portion of the beverage. With the proper sized portion, the child is more likely to finish the beverage serving and thus avoid excessive waste. Also, with the proper sized portion the beverage container of the present invention is more manageable for a small child because the child does not have to hold, lift and manipulate a container that is too heavy. For example, a small child is capable of holding and manipulating a small container (i.e. 4-8 ounces), however, it is difficult for a child to use a container that holds 16 to 20 ounces which is the common size for typical bottled beverage containers.

Finally, the invention provides a dispensing cap and beverage bottle assembly that is well suited for use by a small child because the design and operation of the dispensing cap and beverage bottle assembly is intuitive for the child. Most small children are very familiar with the use of a common sipper cup. Consequently, the transition to the use of the dispensing cap and bottle assembly disclosed herein is a natural and seamless transition for the child. Additionally, the invention is safe for use by a small child because there are no sharp edges or moving parts.

For a fuller understanding of the nature and advantages of the present invention, reference should be made to the ensuing detailed description and claims, taken in conjunction with the accompanying drawings.

### BRIEF DESCRIPTION OF THE DRAWINGS

The components in the figures are not necessarily to scale, emphasis instead being placed upon illustrating the principles of the invention. In the figures, like reference numerals designate corresponding parts or structure throughout the different views.

FIG. 1 is an isometric view of one embodiment for a child's fluid dispensing cap and bottle assembly, as viewed from above;

FIG. 2 is an exploded isometric view of one embodiment for a child's fluid dispensing cap and bottle assembly, as viewed from above;

FIG. 3A is an isometric view of one embodiment for a child's fluid dispensing cap, as viewed from above;

FIG. 3B is an exploded isometric view of one embodiment for a child's fluid dispensing cap, as viewed from below;

FIG. 3C is a front view of one embodiment for a child's fluid dispensing cap;

FIG. 3D is a cross-sectional side view taken along section line D-D of FIG. 3C;

FIG. 3E is a top view of one embodiment for a child's fluid dispensing cap;

FIG. 3F is an enlarged section view of a portion of a perforated baffle illustrating fluid dynamics (restricted fluid flow) for a single hole formed within the baffle;

FIG. 3G is an enlarged section view of a portion of a perforated baffle illustrating fluid dynamics (commenced fluid flow) for a single hole formed within the baffle;

FIG. 4 is an isometric view of an alternate embodiment for a child's fluid dispensing cap and bottle assembly, as viewed from above;

FIG. 5 is an exploded isometric view of an alternate embodiment for a child's fluid dispensing cap and bottle assembly, as viewed from above;

FIG. 6A is an isometric view of an alternate embodiment for a child's fluid dispensing cap, as viewed from above;

FIG. 6B is an exploded isometric view of an alternate embodiment for a child's fluid dispensing cap, as viewed from below;

FIG. 6C is a front view of an alternate embodiment for a child's fluid dispensing cap;

FIG. 6D is a cross-sectional side view taken along section line D-D of FIG. 6C;

FIG. 6E is a top view of an alternate embodiment for a child's fluid dispensing cap;

FIG. 6F is an enlarged section view of a portion of a perforated baffle illustrating fluid dynamics (restricted fluid flow) for a single hole formed within the baffle; and

FIG. 6G is an enlarged section view of a portion of a perforated baffle illustrating fluid dynamics (commenced fluid flow) for a single hole formed within the baffle.

### DETAILED DESCRIPTION OF THE PREFERRED EMBODIMENTS

The invention relates to a a child's fluid dispensing cap and bottle assembly. In the following description, numerous specific details are set forth in order to provide a more thorough description of the present invention. It will be apparent, however, to one skilled in the art, that the present invention may be practiced without these specific details. In other instances, well-known features and processes have been indicated although not described in detail so as not to obscure the invention.

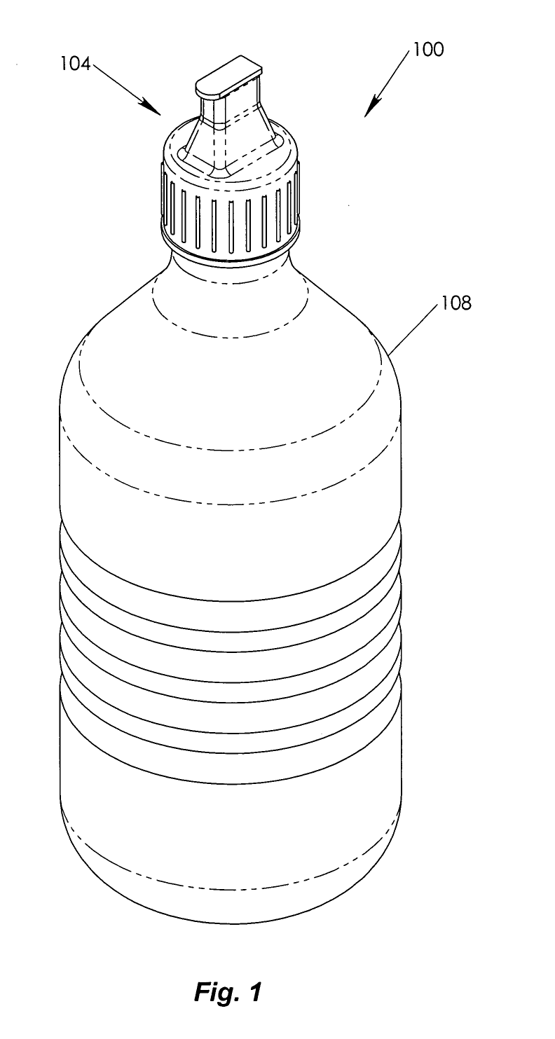

Referring to the figures, FIG. 1 shows one embodiment of a child's fluid dispensing cap and bottle assembly 100 comprising a fluid dispensing cap 104 and a conventional beverage bottle 108. The fluid dispensing cap 104 and bottle 108 are preferably fabricated using conventional injection molding techniques using suitable materials such as polypropylene, pvc, polycarbonate or polyetheylene. The thermoplastic material should meet FDA and other government standards for food-contact use.

In a specific example, the cap 104 and bottle 108 has a molded nominal thickness between about 0.01 and 0.06 of an inch. The bottle 108 defines a beverage storage volume from about 2 ounces to 8 ounces and is suitable for containing various beverages such as water, milk, juice, or energy drinks to name a few.

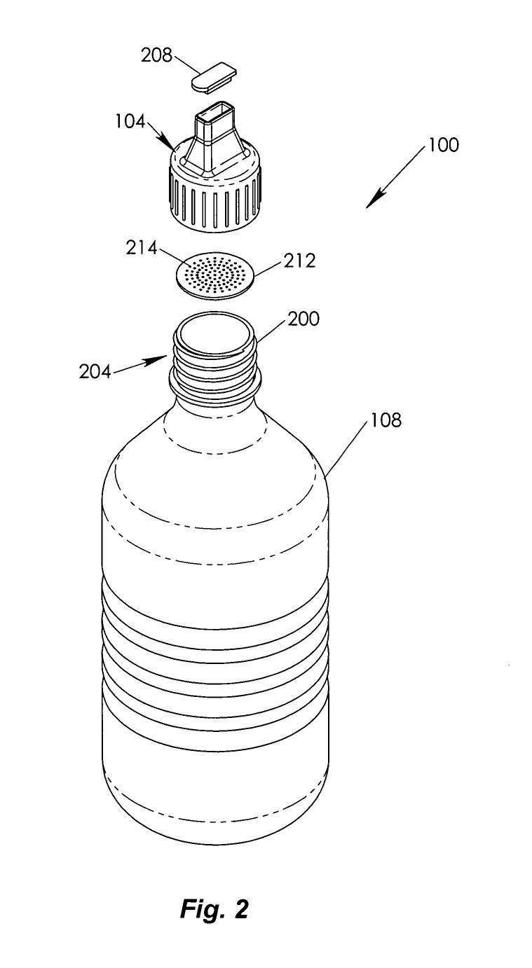

FIG. 2 is an exploded isometric view of one embodiment of a child's fluid dispensing cap and bottle assembly 100. The bottle 108 has circumferential external threads 200 integrally formed around a bottle neck 204 region. The external threads 200 provide for operative engagement with an internally threaded portion in cap 104. A sealing member 208 is applied to the cap 104 to prevent leaking, after filling, and to additionally provide an indication of tampering and thus insures the integrity of the beverage contents. The sealing member 208 has a protrusion (not shown) that mates with an opening in the cap 104. Although a break-away seal has been illustrated, other types of tamper resistant seals are suitable such as peel-off adhesive seals, resilient plugs, and shrink wrap seals to name a few. As will be apparent to those of ordinary skill in the art, various sealing methods for adequately sealing the beverage container and providing an indication of tampering are suitable.

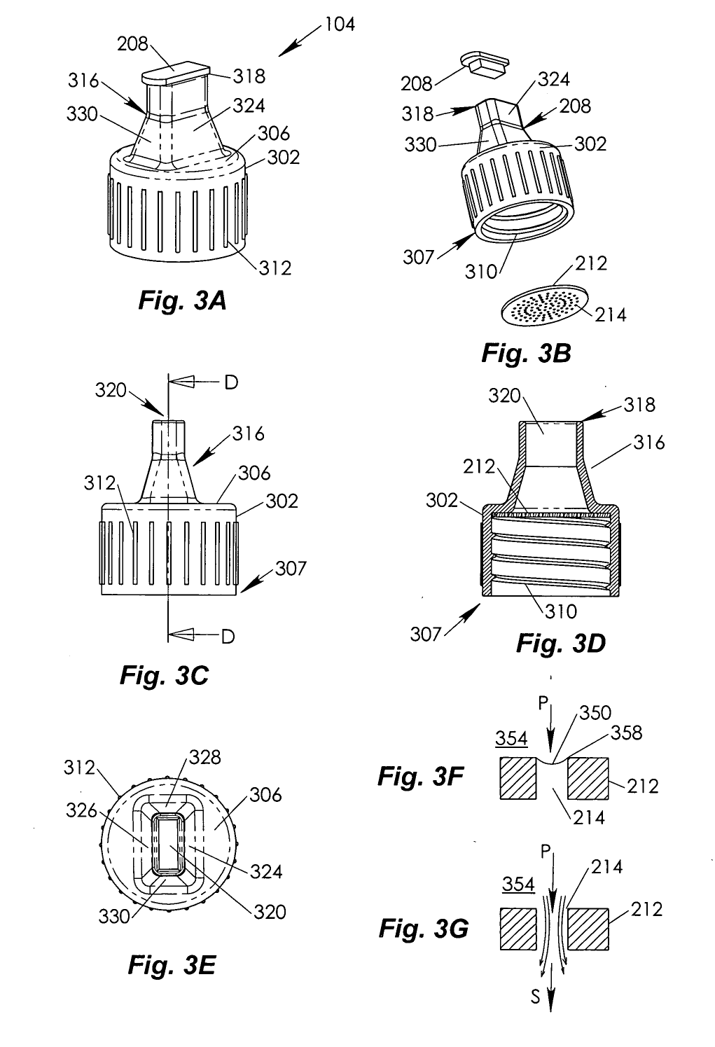

A perforated baffle 212 controls fluid flow from the bottle 108 through the fluid dispensing cap 104. The control of fluid flow through the baffle 212 is discussed in greater detail below with reference to FIGS. 3F and 3G. The baffle 212 is preferably fabricated from a substantially rigid thermoplastic such as polypropylene, pvc, polycarbonate or polyetheylene. The thermoplastic material should meet FDA and other government standards for food-contact use. The baffle 212 has a plurality of holes 214 formed there through that provide a fluid pathway through the baffle 212. In one embodiment the holes 214 are arranged in a substantially radial pattern: however, other geometrical arrangements are suitable such as rectangular patterns. The baffle 212 is sized to match the outside diameter of the bottle neck 204 while still permitting the fluid dispensing cap 104 to be operatively threaded onto the bottle neck 204 and thus capture the baffle 212 between the bottle neck 204 and the fluid dispensing cap 104. Although baffle 212 is described as a separate element, it may be integrally formed with cap.

The structure and function of the preferred embodiment is shown and will now be described with reference to FIGS. 3A through 3E. The fluid dispensing cap 104 includes a hollow cylindrical base member 302 having a top surface 306, a bottom end 307 and an internal threaded surface 310. The internal threaded surface 310 operatively engages with mating external threads 200 of bottle 108 and enables the cap 104 to be screwed onto the bottle 108. The base member 302 further includes a plurality of grasping ridges 312 integrally formed around the circumference of the base member 302. The ridges 312 provide an enhanced gripping surface to facilitate installation and removal of the fluid dispensing cap 104 from the bottle 108.

The fluid dispensing cap 104 also includes a drinking spout 316 integrally formed with the top surface 306 and generally extending away from the base member 302 to a distal end 318. The drinking spout 316 defines a rectangular fluid outlet passage 320 of about 0.25 by 0.5 inches. Additionally, the drinking spout 316 is shaped and sized to be comfortably received in a users's mouth for consuming the beverage contained within the bottle 108. The drinking spout 316 generally extends about 0.25 to 0.75 of an inch from the top surface 306 of the base member 302 to the distal end 318. As best shown in FIG. 3E, the drinking spout 316 comprises a first side wall 324, a second side wall 326, a first end wall 328 and a second end wall 330 and generally forms a rectangular shape. The drinking spout has general overall dimensions of about 0.8 by 0.5 inches. In the preferred embodiment, the first and second side walls have a dimension that exceeds the dimension of the first and second end wall. In other embodiments, the drinking spout has other geometric cross-sectional profiles such as circular, oval, triangular and the like. As will be apparent to those of ordinary skill in the art various shapes, sizes and contours of the spout's wall structure can be varied and still define a geometrically shaped fluid outlet passage.

Reference is now made to FIG. 3F which is an enlarged section view of a portion of the perforated baffle 212 illustrating the fluid dynamics of restricted fluid flow for a single hole formed within the baffle. As shown in FIG. 3F, there is a formation of a stable fluid meniscus 350, of the beverage contained within the bottle 108, extending into hole 214 from its inner end, under static pressure “P” applied by the weight of the liquid in the bottle 108 when the bottle 108 is inverted. A fluid membrane at the free surface of the meniscus establishes a surface tension that resists the rupture of the fluid membrane and the undesired leakage of the fluid through the hole. The level of pressure “P” that can be resisted by such surface tension is a function of the relative surface energies of both the fluid 354 and the interface 358 between the edge of the baffle 212 and the meniscus 350. Resistance to leakage will also depend on fluid viscosity and hole dimensions. For many liquids commonly consumed by small children, such as fruit juices, water and whole milk, circular holes 214 of a diameter about 0.025 inch acceptably resist leakage under a quasi-static pressure differential across the baffle 212. Preferably, the drinking spout 316 should not substantially leak more than a few drops of liquid over a relatively short time interval (i.e., 5-10 seconds), with no pressure differential applied across the perforated baffle 212, and after being gently rotated to an inverted position. Although a few drops may escape when gently inverted, once the pressure differential reaches steady-state condition, the seepage will cease and the surface tension of the fluid will restrict fluid flow across the baffle.

Conversely, when a sub-atmospheric pressure “S” or suction is applied to the drinking spout 316 and thus to the non-fluid side of hole 214 as shown in FIG. 3G, with the bottle 108 inverted, the maximum surface tension capacity of the meniscus 350 is exceeded and fluid flow will commence through the baffle 212. Once flow begins, it is likely to continue even if suction is removed. Because of this tendency, and because baffle 212 contains no deformable or movable sealing surface to stop the flow when suction is removed, it is recommend that holes 214 be sized small enough that such flow will rarely be initiated without applied suction. Of course, conditions will arise that can cause undesirable flow initiation in the absence of suction, such as applying increased pressure (i.e., squeezing) the bottle 108, in which case the surface tension of the fluid meniscus 350 will be increased such that the meniscus 350 ruptures and fluid flow across the baffle 212 is initiated. However for many commercial applications the functional advantage of the present invention outweighs concerns of slight seepage across the baffle 212.

Since each hole 214 of the spout 316 is small enough to avoid leakage under normal non-suction conditions, an acceptable flow rate under drinking conditions is obtained by providing a sufficient number of holes. Preferably, the holes 214 form an aggregate flow area, perpendicular to the flow path, sufficient to provide a flow rate of approximately 1.0 grams of liquid over a 10 second interval; with the assembly 100 inverted, about 2 ounces of fluid contained within the bottle 108, and a slight vacuum or suction applied across the baffle after inversion of the assembly 100. In one arrangement shown in FIG. 3B, the baffle 212 has a plurality of separate holes 214, each with a diameter of about 0.010 to 0.020 inch, forming an aggregate flow area that provides an adequate fluid flow rate. In some other arrangements, the greater the number of holes in the baffle 212, the smaller each individual hole 214 need be formed, thus decreasing the probability of leakage while still maintaining an acceptable fluid flow rate during use of the assembly 100.

Referring to FIGS. 1 and 3A-3E, the fluid dispensing cap 104 and bottle 108 is operatively sealed with the exception of the fluid outlet passage 320 of drinking spout 316. In one embodiment, an elastomeric seal (i.e., flexible material such as soft rubber or silicone) is provided between the cap 104 and bottle 108. As a result of the operative seal, no vent air is permitted to flow into the cup as the liquid is dispensed. An air tight seal is maintained between the base member 302 and the bottle neck region 204, such that a slightly sub-atmospheric pressure will develop within the conventional beverage bottle 108 during drinking. As soon as drinking stops and the bottle 108 is positioned upright, air will enter the bottle 108 through the holes 214 to eliminate any pressure differential within the bottle 108. This type of venting is acceptable for many applications, as children beyond nursing age do not typically maintain suction indefinitely while drinking. Furthermore, with beverage bottle 108 formed to have a particularly thin wall thickness, any substantial vacuum within the bottle 108 will only tend to temporarily buckle the body wall of the bottle 108. If desired, the cap 104 may be configured to allow some venting to occur through a dedicated vent aperture.

The presently preferred method of forming the drinking holes 214 in baffle 212 is to form the holes as the baffle 212 itself is molded, rather than performing a post-molding operation to form the holes. Alternatively, the drinking holes may be formed by piercing or laser cutting, although these processing steps tend to add cost and can, in some cases, produce more variability in hole properties than molding. The properties of the hole-defining surface by which the edge of the stable liquid free surface forms (e.g., at the interface edge 358 of baffle 212 as shown in FIG. 3F) are considered particularly important, it is recommend to maintain close tolerances and strict quality controls regarding the geometric shape of holes 214. Frequent replacing or repairing of worn mold surfaces that form holes 214 prevents abnormalities in the hole forming process.

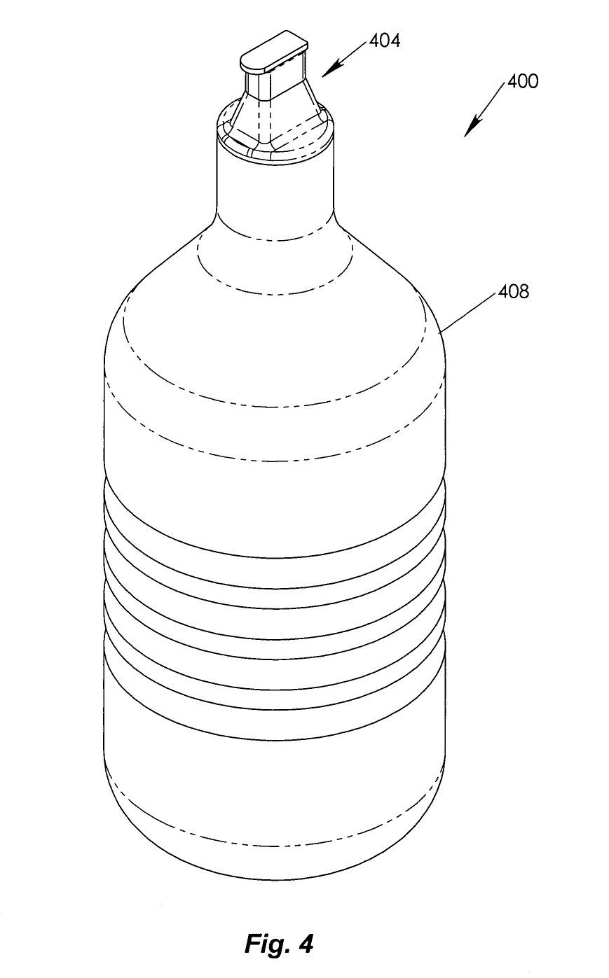

FIG. 4 is an isometric view of an alternate embodiment for a child's fluid dispensing cap and bottle assembly which shows a child's fluid dispensing cap and bottle assembly 400. As seen in FIG. 4, the assembly 400 comprises a press-in fluid dispensing plug 404 and a conventional beverage bottle 408. The press-in dispensing cap 404 and bottle 408 are preferably of unitary construction consisting of conventional injection molding techniques using suitable materials such as polypropylene, pvc, polycarbonate or polyetheylene. The thermoplastic material should meet FDA and other government standards for food-contact use.

In a specific example, the press-in dispensing cap 404 and bottle 408 has a molded nominal thickness between about 0.01 and 0.06 of an inch. The bottle 408 defines a beverage storage volume from about 2 ounces to 8 ounces and is suitable for containing various beverages such as water, milk, juice, or energy drinks to name a few.

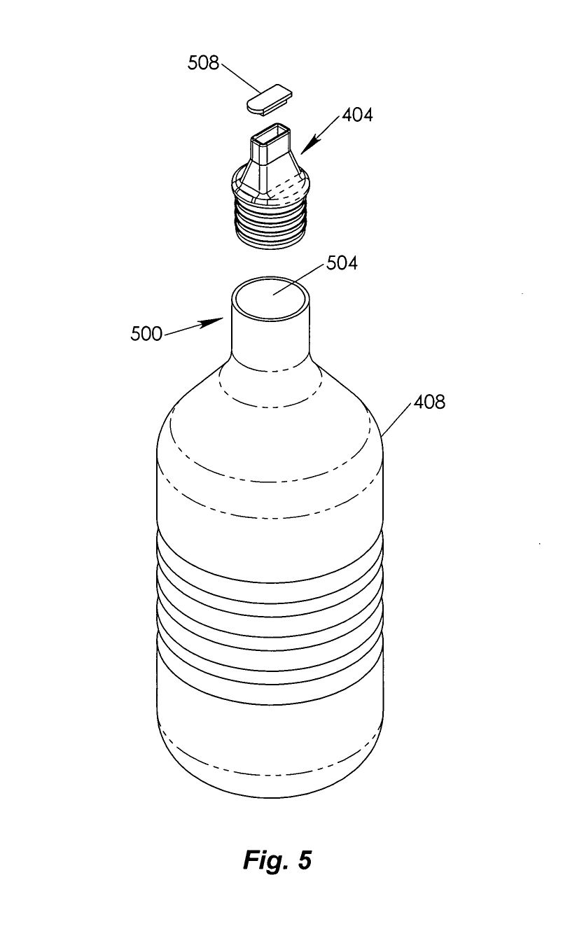

Next FIG. 5 shows an exploded isometric view for an alternate embodiment of a child's fluid dispensing cap and bottle assembly 400. The bottle 408 has a bottle neck region 500 having an internal diameter surface 504. The internal diameter surface 504 provides for operative engagement for a mating portion in cap 404. A sealing member 508 is applied to the cap 404 to prevent leaking during manufacturing and to additionally provide an indication of tampering and thus insures the integrity of the beverage contents. The sealing member 508 has a protrusion that mates with the opening in the cap 404. Although a break-away seal has been illustrated, other types of tamper resistance seals are suitable such as peel-off adhesive seals, resilient plugs, and shrink wrapping to name a few. As will be apparent to those of ordinary skill in the art, various sealing methods for adequately sealing the beverage container and providing an indication of tampering are suitable.

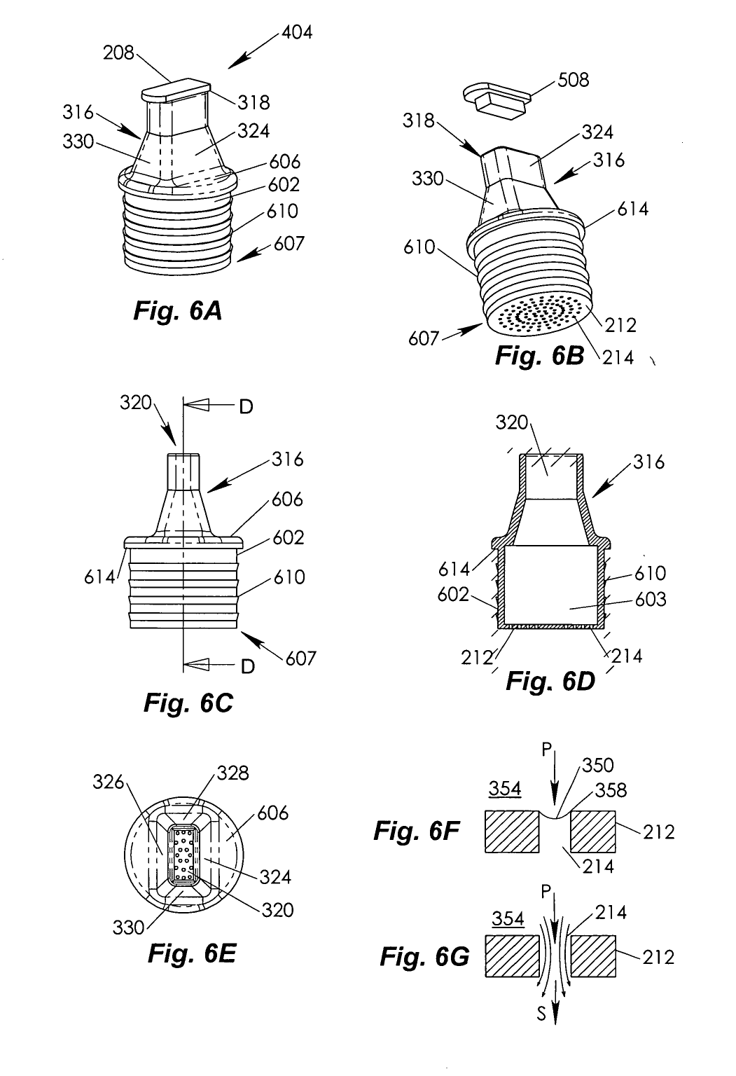

An alternate embodiment is shown and will now be described with reference to FIGS. 6A through 6E. The press-in fluid dispensing cap 404 includes a substantially hollow cylindrical base member 602 defining a cavity 603 and having a top surface 606, a bottom end 607 and a plurality of circumferential ribs 610. The ribs 610 are integrally formed with the outer surface of the base member 602. Additionally, the ribs 610 operatively engage an internal diameter surface 504 of bottle 408 and this enables the cap 404 to be press-fit into the bottle 408. The ribs 610 provide a gripping surface to facilitate coupling between the cap 404 and the bottle 408 because the outer diameter of the ribs 610 is slightly larger than the inside diameter of the bottle neck 500 opening. The base portion 602 further includes a retention ridge 614 formed around the circumference of the base member 602 and extending radially outward from the top surface 606. In this embodiment the ridge 614 extends the thickness of the bottle neck 500. For example, the outer diameter of ridge is substantially equivalent to the outside diameter of the bottle neck 500.

A perforated baffle 212 controls fluid flow from the bottle 408 through the press-in fluid dispensing cap 404. The control of fluid flow through the baffle 212 is discussed in greater detail below with reference to FIGS. 6F and 6G. As best shown in FIG. 6B, the baffle 212 is integrally formed on the bottom end 607 of base member 602. Turning to FIG. 6D, which clearly shows the baffle 212, of this alternate embodiment, integrally formed with the bottom end 607 and structurally forming the cavity 603. The baffle 212 is preferably fabricated from the same material as the press-in fluid dispensing cap 404. Additionally, the baffle 212 has a plurality of holes 214 formed there through that provide a fluid pathway through the baffle 212. In one embodiment the holes 214 are arranged in a substantially radial pattern, however other geometrical arrangements are suitable such as rectangular patterns.

The fluid dispensing cap 404 also includes a drinking spout 316 integrally formed with the top surface 606 and generally extending away from the base member 602 to a distal end 318. The drinking spout 316 defines a rectangular fluid outlet passage 320 of about 0.25 by 0.5 inches. Additionally, the drinking spout 316 is shaped and sized to be comfortably received in a users's mouth for consuming the beverage contained within the bottle 408. The drinking spout 316 generally extends about 0.25 to 0.75 of an inch from the top surface 606 of the base member 602 to the distal end 318. As best shown in FIG. 6E, the drinking spout 316 comprises a first side wall 324, a second side wall 326, a first end wall 328 and a second end wall 330 and generally forms a rectangular shape. The drinking spout 316 has general overall dimensions of about 0.8 by 0.5 inches. The first and second side walls have a dimension that exceeds the dimension of the first and second end wall. In other embodiments, the drinking spout has other geometric cross-sectional profiles such as circular, oval, triangular and the like. As will be apparent to those of ordinary skill in the art, various shapes, sizes and contours of the spout's wall structure can be varied and still define a geometrically shaped fluid outlet passage.

Reference is now made to FIG. 6F which is an enlarged section view of a portion of a perforated baffle illustrating fluid dynamics of restricted fluid flow for a single hole formed within the baffle. FIG. 6F illustrates the formation of a stable fluid meniscus 350, of the beverage contained within the bottle 408, extending into hole 214 from the beverage storage volume, under static pressure “P” applied by the weight of the liquid in the bottle 408 when the bottle 408 is inverted. A fluid membrane at the free surface of the meniscus 350 establishes a surface tension that resists the rupture of the fluid membrane and the undesired leakage of the fluid through the hole 214. The level of pressure “P” that can be resisted by such surface tension is a function of the relative surface energies of both the fluid 354 and the interface 358 between the edge of the baffle 212 and the meniscus 350. Resistance to leakage will also depend on fluid viscosity and hole dimensions. For many liquids commonly consumed by small children, such as fruit juices, water and whole milk, circular holes 214 of a diameter about 0.025 inch acceptably resist leakage under a quasi-static pressure differential across the baffle 212. Preferably, the drinking spout 316 should not substantially leak more than a few drops of liquid over a relatively short time interval (i.e., 5-10 seconds), with no pressure differential applied across the perforated baffle 212, and after being gently rotated to an inverted position. Although a few drops may escape when gently inverted, once the pressure differential reaches steady-state condition, the seepage will cease and the surface tension of the fluid will restrict fluid flow across the baffle.

Conversely, when a sub-atmospheric pressure “S” or suction is applied to the drinking spout 316 and thus to the non-fluid side of hole 214 as shown in FIG. 6G, with the bottle 408 inverted, the maximum surface tension capacity of the meniscus 350 is exceeded and fluid flow will commence through the baffle 212. Once flow begins, it is likely to continue even if suction is removed. Because of this tendency, and because baffle 212 contains no deformable or movable sealing surface to stop the flow when suction is removed, it is recommend that holes 214 be sized small enough that such flow will rarely be initiated without applied suction. Of course, conditions will arise that can cause undesirable flow initiation in the absence of suction, such as applying increased pressure (i.e., squeezing) the bottle 408, in which case the surface tension of the fluid meniscus 350 will be increased such that the meniscus 350 ruptures and fluid flow across the baffle 212 is initiated. However for many commercial applications the functional advantage of the present invention outweighs concerns of slight seepage across the baffle 212.

Since each hole 214 is small enough to avoid leakage under normal non-suction conditions, an acceptable flow rate under drinking conditions is obtained by providing a sufficient number of holes. Preferably, the holes 214 form an aggregate flow area, perpendicular to the flow path, sufficient to provide a flow rate of approximately 1.0 grams of liquid over a 10 second interval; with the assembly 400 inverted, about 2 ounces of fluid contained within the bottle 108, and a slight vacuum or suction applied across the baffle 212 after inversion of the assembly 400. In one arrangement shown in FIG. 6B, the baffle 212 has a plurality of separate holes 214, each with a diameter of about 0.010 to 0.020 inch, forming an aggregate flow area that provides an adequate fluid flow rate. In some other arrangements, the greater the number of holes in the baffle 212, the smaller each individual hole 214 need be formed, thus decreasing the probability of leakage while still maintaining an acceptable fluid flow rate during use of assembly 400.

Referring to FIGS. 4 and 6A-6E, the press-in fluid dispensing cap 404 and bottle 408 is operatively sealed with the exception of the fluid outlet passage 320 of drinking spout 316. As a result of the operative seal, no vent air is permitted to flow into the cup as the liquid is dispensed. An air tight seal is maintained between the base member 602 and the bottle neck 500, such that a slightly sub-atmospheric pressure will develop within the conventional beverage bottle 408 during drinking. As soon as drinking stops and the bottle 408 is positioned upright, air will enter the bottle 408 through the holes 214 to eliminate any pressure differential within the bottle 408. This type of venting is acceptable for many applications, as children beyond nursing age do not typically maintain suction indefinitely while drinking. Furthermore, with beverage bottle 408 formed to have a particularly thin wall thickness, any substantial vacuum within the bottle 408 will only tend to temporarily buckle the body wall of the bottle 408. If desired, the press-in cap 404 is configured to allow some venting to occur through a dedicated vent aperture.

The presently preferred method of forming the drinking holes 214 in baffle 212 is to form the holes as the press-in cap 404 and baffle 212 are molded, rather than performing a post-molding operation to form the holes. Alternatively, the drinking holes may be formed by piercing or laser cutting, although these processing steps tend to add cost and can, in some cases, produce more variability in hole properties than molding. The properties of the hole-defining surface by which the edge of the stable liquid free surface forms (e.g., at the interface edge 358 of baffle 212 shown in FIG. 6F) are considered particularly important, it is recommend to maintain close tolerances and strict quality controls regarding the geometric shape of holes 214. Frequent replacing or repairing worn mold surfaces that form holes 214 prevents abnormalities in the hole forming process.

In operation, the fluid dispensing cap is coupled with the beverage bottle by either operatively threading the base member onto the bottle neck or inserting the bottom end of the cap into the opening of the bottle neck as shown and described in the preferred and alternate embodiments, respectively. Preferably, the bottle is filled with a consumable beverage prior to installing the fluid dispensing cap. However, other methods of filling the bottle after assembly of the cap and bottle are suitable such as pressure filling through the spout. Additionally, it is possible to fill the assembly and then subsequently seal an alternate opening formed on the bottle. For example, the bottle may have an opening for filing on the bottom of the bottle and once the assembly is filled the opening could be sealed by known thermoforming processes. In use, a fluid is drawn from within the cap and bottle assembly by causing a pressure differential across the perforated baffle (i.e., by applying a suction on the drinking spout). The pressure differential subsequently causes an increase in the surface tension of a fluid membrane formed across the perforated holes of the baffle. As the surface tension increases a limit is reached in the fluid membrane. Once the limit is exceeded, the fluid membrane will rupture and fluid will flow across the perforated baffle and out of the drinking spout's outlet passage. Upon equalization of the pressure differential across the perforated baffle, atmospheric conditions are restored and the fluid membrane reforms across the holes and the fluid flow will discontinue.

The fluid dispensing cap and beverage bottle assembly disclosed herein provides several advantages not found in known pre-packaged bottled beverage containers particularly suited for consumption by small children.

Firstly, the invention provides a spill-resistant pre-packaged bottled beverage container for use by small children. As a result, a person or parent taking care of a small child can provide the child with a beverage and not have to worry about spilling a substantial portion of the beverage. This is especially beneficial when traveling with a small child because spills inside a vehicle are less likely and there is a reduced concern of having the child's clothing saturated with the beverage. Additionally, the spill resistant functionality of the present invention reduces the concern of damage to adjacent surfaces in the event of a spill.

Secondly, the invention enables the preparation of a store bought pre-packaged bottled beverage that contains a child sized portion of the beverage. With the proper sized portion, the child is more likely to finish the beverage serving and thus avoid excessive waste. Also, with the proper sized portion the beverage container of the present invention is more manageable for a small child because the child does not have to hold, lift and manipulate a container that is too heavy. For example, a small child is capable of holding and manipulating a small container (i.e. 4-8 ounces), however, it is difficult for a child to use a container that holds 16 to 20 ounces which is the common size for typical bottled beverage containers.

Finally, the invention is well suited for use by a small child because the design and operation of the dispensing cap and beverage bottle assembly is intuitive for the child. Most small children are very familiar with the use of a common sipper cup. Consequently, the transition to the use of the dispensing cap and bottle assembly disclosed herein is a natural and seamless transition for the child. Additionally, the invention is safe for use by a small child because there are no sharp edges or moving parts.

Although the above provides a full and complete disclosure of the preferred embodiments of the invention, various modifications, alternate constructions and equivalents will occur to those skilled in the art. For example, the threaded cap and separate baffle embodiment may be combined to form a unitary construction. Also, the dispensing cap may be integrally formed as a single unit with the bottle. Additionally, the invention may be adapted for use by an adult such as an elderly or disabled person. Therefore, the disclosure should not be construed as limiting the invention, which is defined by the claims.

What is claimed:

1. A spill-resistant fluid dispensing cap comprising:
a substantially hollow cylindrical base member having a top surface, a bottom end, an inner surface and an outer surface;
a drinking spout integrally formed on said top surface and extending generally outwardly therefrom, said spout defining an outlet passage; and
a perforated baffle coupled to said base member, said baffle having a plurality of holes, for providing a fluid pathway through said baffle, said holes being sized such that fluid flow through the baffle commences when a pressure differential is applied across said baffle.

2. The spill-resistant fluid dispensing cap of claim 1, wherein said inner surface of said base member is threaded, in order to operatively engage an associated bottle having an externally threaded neck portion for receiving said dispensing cap.

3. The spill-resistant fluid dispensing cap of claim 1, wherein said base member further comprises a plurality of circumferential ribs integrally formed on said outer surface, said ribs configured for press-fit engagement within a bottle neck.

4. The spill-resistant fluid dispensing cap of claim 1, wherein said perforated baffle is integrally formed with said base member.

5. The spill-resistant fluid dispensing cap of claim 4, wherein said perforated baffle is integrally formed with said bottom end of said base member.

6. The spill-resistant fluid dispensing cap of claim 1, further comprising a sealing member coupled with said outlet passage.

7. The spill-resistant fluid dispensing cap of claim 1, wherein said dispensing cap is coupled with a beverage bottle.

8. The spill-resistant fluid dispensing cap of claim 7, wherein said beverage bottle has a beverage storage volume of about 2 to 8 fluid ounces.

9. A spill-resistant fluid dispensing cap comprising:
a substantially hollow cylindrical base member having a top surface, a bottom end, an inner surface and an outer surface, said inner surface is threaded in order to operatively engage an associated bottle having an externally threaded neck portion for receiving said dispensing cap;
a drinking spout integrally formed on said top surface and extending generally outwardly therefrom, said spout defining an outlet passage;
a perforated baffle coupled with said base member, said baffle having a plurality of holes for providing a fluid pathway through said baffle, said holes being sized such that fluid flow through the baffle commences when a pressure differential is applied across said baffle; and
a sealing member operatively coupled with said outlet passage.

10. The spill-resistant fluid dispensing cap of claim 9, wherein said perforated baffle is integrally formed with said top surface of said base member.

11. The spill-resistant fluid dispensing cap of claim 9, wherein said dispensing cap is coupled with a beverage bottle.

12. The spill-resistant fluid dispensing cap of claim 11, wherein said beverage bottle has a beverage storage volume of about 2 to 8 fluid ounces.

13. In combination:
a spill-resistant fluid dispensing cap having a substantially hollow cylindrical base member, said base member having a top surface, a bottom end, an inner surface and an outer surface, a drinking spout integrally formed on said top surface and extending generally outwardly therefrom, said spout defining an outlet passage; a perforated baffle coupled with said base member, said baffle having a plurality of holes for providing a fluid pathway through said baffle, said holes being sized such that fluid flow through the baffle commences when a pressure differential is applied across said baffle; and
a beverage bottle having a beverage storage volume, and a bottle neck configured for operative coupling with said spill-resistant fluid dispensing cap;
whereby the coupling of said fluid dispensing cap with said beverage bottle enables drinking of a fluid contained within said storage volume only when a pressure differential is applied across said perforated baffle.

14. The spill-resistant fluid dispensing cap of claim 13, wherein said inner surface of said base member is threaded in order to operatively engage an associated bottle having an externally threaded neck portion for receiving said dispensing cap.

15. The spill-resistant fluid dispensing cap of claim 13, wherein said base member further comprises a plurality of circumferential ribs integrally formed on said outer surface, said ribs configured for press-fit engagement within a bottle neck.

16. The spill-resistant fluid dispensing cap of claim 13, wherein said perforated baffle is integrally formed with said base member.

17. The spill-resistant fluid dispensing cap of claim 16, wherein said perforated baffle is integrally formed with said bottom end of said base member.

18. The spill-resistant fluid dispensing cap of claim 13, further comprising a sealing member coupled with said outlet passage.

19. The spill-resistant fluid dispensing cap of claim 18, wherein said sealing member provides an indication of tampering.

20. The spill-resistant fluid dispensing cap of claim 19, wherein said beverage bottle has a beverage storage volume of about 2 to 8 fluid ounces.
